(19) United States
(12) Patent Application Publication
(10) Pub. No.: US 2024/0318032 A1
(43) Pub. Date: Sep. 26, 2024

(54) Insulation System for Electrically Rotating MachinesAnd Method for the Production Thereof

(71) Applicant: Siemens Aktiengesellschaft, München (DE)

(72) Inventors: Marek Maleika, Fürth (DE); Steffen Lang, Hallerndorf (DE)

(73) Assignee: SIEMENS AKTIENGESELLSCHAFT, München (DE)

(21) Appl. No.: 18/547,236

(22) PCT Filed: Feb. 16, 2022
(86) PCT No.: PCT/EP2022/053760

§ 371 Date: Aug. 21, 2023

(30) Foreign Application Priority Data
Feb. 22, 2021 (DE) 10 2021 201 664.2

(51) Int. Cl. C09D 163/00; C09D 5/03; C09D 5/24; C09D 163/04; H02K 3/30; H02K 15/10

(52) U.S. Cl. CPC C09D 163/00; C09D 5/03; C09D 5/24; C09D 163/04; H02K 15/105; H02K 3/30

(57) ABSTRACT

Various embodiments of the teachings herein include a powder coating or wet enamel for production of an insulation system of an electrical machine including a curable resin-resin or resin-hardener mixture in solid form as a powder coating formulation at room temperature or processed in a solvent to give a wet enamel. The mixture may include: a first hydrocarbon-based resin component with at least two epoxy groups; a second silicon-oxygen-based resin component with at least one hydroxyl functionality; and a hardener and/or an initiating catalyst. The first resin component is predominant by composition.

### CROSS-REFERENCE TO RELATED APPLICATIONS

This application is a U.S. National Stage Application of International Application No. PCT/EP2022/053760 filed Feb. 16, 2022, which designates the United States of America, and claims priority to DE Application No. 10 2021 201 664.2 filed Feb. 22, 2021, the contents of which are hereby incorporated by reference in their entirety.

### TECHNICAL FIELD

The present disclosure relates to electrical machines. Various embodiments of the teachings herein include insulation systems for an electrical rotating machine, e.g. electric motor and/or generator and methods of producing such an insulation system.

### BACKGROUND

Electrical rotating machines are known in the low-and high-voltage sector, such as electric motors and electrical generators. These machines are notable for a multitude of different designs and fields of use; they are used in all fields of technology, industry, everyday life, transport, medicine and other fields. The performance range of electrical machines extends from orders of magnitude below one microwatt, for example in microsystems technology, up to more than one gigawatt, for example in the power plant sector. Between these lie applications with traction and drive motors in the vehicle sector, rail vehicle sector, etc.

In electrical rotating machines in the high-and/or low-voltage sector, there are coils composed of part-conductors that are insulated from one another, for example, by means of winding and/or wire enamel. These are formed from blanks, such as a coil loop, by drawing and twisting, such that they can be inserted into the slots of a main stator body, i.e. into the laminated stack of the electric motor. The coils are connected to one another via what are called winding heads and contacted by corresponding terminals.

The current-conducting coils are insulated from one another, from the laminated stack and ultimately also from the environment by an insulation system. The insulation system regularly comprises multiple components: the main insulation, which is a winding based on epoxide-, polyester- or polyesterimide-impregnated mica tapes, ensures insulation of the conductors under high-voltage, especially of copper conductors with respect to the grounded stator. It has a high partial discharge use voltage, which enables it to dissipate 2.0-3.5 kV per millimeter, for example, in a sustained manner.

The most important components of an insulation system, viewed from the inside outward, are the partial conductor insulation, main insulation, optionally outer corona shield (AGS) and optionally terminal corona shield (EGS). The “inside” here refers to the plane of the conductors, especially copper conductors, which firstly have a relatively thin first insulation layer, the partial conductor insulation, which form the electrical coil. All insulation systems have a main insulation and—depending on the rated voltage of the electrical rotating machine—on top of this there is an outer corona shield—AGS—and optionally a terminal corona shield—EGS.

High voltages arise in operation of the electrical rotating machine, which have to be dissipated in the insulation volume between the conductor bar at high voltage and the laminated stack at ground potential. High excess fields arise here at the edges of the laminates in the laminated stack, and these can cause partial discharges. These partial discharges lead to very significant heating locally when they meet the insulation system. This breaks down the organic materials of the insulation system gradually to volatile products of low molecular weight, for example to CO2.

All components of the insulation system (main insulation, AGS and EGS) have to date been wound onto the part-conductors, generally as tapes, with parts of this, such as the EGS, applied completely by hand. In the case of motors with smaller rated voltages, as is the case, for example, in traction motors, the main insulation may be configured not as a wound tape but as what is called a slot cell. The other parts may also not be applied a fully automated manner, either because the production run size does not make automation economically viable and/or the risk of trapped air in the folds means that the quality required in the winding operation is not assured.

The tapes that are wrapped and the slot cells that are inserted into the slots for the main insulation generally consist of bonded mica platelets which, in the insulation, serve to extend the erosion pathway in the insulation system, the direct route from the high-voltage side, the conductors, to the grounded laminated stack, which results in a distinctly longer lifetime of an insulation system.

### SUMMARY

The teachings of the present disclosure address the disadvantages of the prior art and may be used to provide a main insulation, an AGS and/or EGS which is producible without or at least mainly without manual application. For example, some embodiments include a powder coating formulation or wet enamel for production of an insulation system of an electrical machine, especially a rotating electrical machine having a rated voltage of at least 700 V, comprising at least one curable resin-resin or resin-hardener mixture which is especially in solid form as a powder coating formulation at room temperature or has been processed in a solvent to give a wet enamel, comprising at least one first resin component which is hydrocarbon-based and has at least two epoxy groups, at least one second resin component which is silicon-oxygen-based and is especially a siloxane compound and/or a silsesquioxane compound or a compound derivatized from these parent compounds and has at least one hydroxyl functionality, and a hardener and/or an initiating catalyst, wherein the hydrocarbon-based resin component is the predominant component in terms of amount.

In some embodiments, the first, hydrocarbon-based resin component comprises a monomeric and/or oligomeric diepoxidized epoxy resin, cycloaliphatic epoxy resin, diglycidyl ether resin and/or epoxidized novolak resin.

In some embodiments, the second, silicon-oxygen-based resin component comprises a monomeric and/or oligomeric glycidyl-based and/or epoxy-terminated and/or hydroxy-terminated and/or hydroxy-functionalized aryl-and/or alkylsiloxane compound.

In some embodiments, the second, silicon-oxygen-based resin component comprises a monomeric and/or oligomeric silsesquioxane compound.

In some embodiments, the powder coating formulation or wet enamel includes fillers.

In some embodiments, the fillers are at least partly electrically conductive.

In some embodiments, the fillers are at least partly electrically insulating.

In some embodiments, thepowder coating formulation or wet enamel includes additives and/or sintering aids.

In some embodiments, there is a cationic hardener comprising at least one compound selected from the group of the organic salts, such as organic ammonium, sulfonium, iodonium and/or phosphonium salts.

In some embodiments, there is an anionic harder comprising at least one compound selected from the group of the imidazolium salts and amines, such as tertiary amines, and/or from the group of the cyanamides, for example dicyanamide, and/or pyrazoles and/or imidazole compounds.

As another example, some embodiments include a method of producing one or more components of an insulation system of an electrical rotating machine, comprising a main insulation, an outer corona shield and/or a terminal corona shield, having the following method steps: a) providing a powder coating formulation and/or a wet enamel comprising a first, hydrocarbon-based resin component and a second, silicon-oxygen-based resin component, and a hardener and/or a catalyst component, followed by b) powder coating and/or wet coating of the coil or bar for production of the main insulation and/or the outer corona shield and/or the terminal corona shield, and optionally repeating steps a) and b) until a given insulation thickness has been attained.

In some embodiments, the method includes providing an electrically conductive powder coating formulation or an electrically conductive wet enamel by introducing an electrically conductive filler into the powder coating formulation and/or into the wet enamel.

In some embodiments, the powder coating is effected by spraying the powder coating formulation and/or the wet coating onto the heated substrate, followed by cooling.

In some embodiments, the powder coating is effected by dipping in a fluidized bed of powder coating.

In some embodiments, the method is performed in an automated manner.

### DETAILED DESCRIPTION

Some embodiments of the teachings herein include a powder coating formulation or wet enamel for production of an insulation system of an electrical machine, especially a rotating electrical machine having a rated voltage of at least 700 V, comprising at least one curable resin-resin or resin-hardener mixture which is especially in solid form as a powder coating formulation at room temperature or has been processed in a solvent to give a wet enamel, comprising
at least one first resin component which is hydrocarbon-based and has at least two epoxy groups,
at least one second resin component which is silicon-oxygen-based and is especially a siloxane compound and/or a silsesquioxane compound or a compound derivatized from these parent compounds and has at least one hydroxyl functionality, and
a hardener and/or an initiating catalyst,
wherein the hydrocarbon-based resin component is the predominant component in terms of amount.

Some embodiments include a method of producing one or more components of an insulation system of an electrical rotating machine, comprising a main insulation, an internal potential controller, an outer corona shield and/or a terminal corona shield, including:
providing a powder coating formulation and/or a wet enamel comprising a first, hydrocarbon-based resin component and a second, silicon-oxygen-based resin component, and a hardener and/or a catalyst component, followed by
powder coating and/or wet coating of the coil or bar for production of the main insulation
optionally providing a powder coating formulation or a wet enamel for the outer corona shield and/or the terminal corona shield,
optionally powder coating and/or wet enameling the outer corona shield and/or the terminal corona shield.

In some embodiments, the powder coating is conducted by spraying the heated substrate and then cooling-for example to room temperature.

In some embodiments, the wet enameling is conducted by application, especially by spraying and/or dip coating the wet enamel, followed by drying and/or removing the solvent.

In some embodiments, the powder coating is conducted by dipping the bar or coil into a fluidized powder coating bed containing the powder coating formulation in powder form in an air stream.

In some embodiments, the providing of the powder coating formulation and/or the wet enamel for the AGS and/or EGS is supplemented by the addition of electrically conductive filler, optionally in two or more fractions.

In some embodiments, the powder coating and/or the wet enameling is conducted in an automated manner.

In some embodiments, the resin-resin or resin-hardener mixture which is in solid form at room temperature or has been processed in a solvent to give the wet enamel also comprises insulating fillers, especially inorganic and/or mineral fillers, in two or more fractions, especially with regard to shape and size, and sintering aids and/or additives, such as levelling and degassing additives. In the provision of a powder coating or wet enamel for production of an electrically partly conductive (EGS) or conductive component (AGS) of the insulation system, electrically conductive fillers are added to the powder coating formulation, optionally in two or more fractions.

In some embodiments, a resin-resin mixture is also present without hardener, but with catalyst or initiator, when the curing to give a thermoset is effected via a homopolymerization. But when two different monomeric or oligomeric compounds cure to give the thermoset, a resin-hardener mixture is present, which undergoes addition polymerization, which requires a hardener in a stoichiometric amount.

The first resin component which, for example, is in solid form at room temperature or has been processed in a solvent to give the wet enamel is, as stated, hydrocarbon-based with at least two epoxy groups; for example this resin component is selected from the group of the epoxy resins, diglycidyl ether resins, novolaks and/or cycloaliphatic epoxy resins, and any mixtures of the compounds mentioned.

In some embodiments, these are one or more monomeric or oligomeric resin component(s) with a backbone comprising carbon—i.e. —[—CR₁R₂—]n-units. R here is hydrogen, aryl, alkyl, heterocycles, nitrogen-, oxygen-and/or sulfur-substituted aryls and/or alkyls. Particularly suitable examples are epoxy-functionalized components, such as bisphenol F diglycidyl ether (BFDGE) or bisphenol A diglycidyl ether (BADGE), polyurethane and mixtures thereof. Preference is given to epoxy resins based on bisphenol F diglycidyl ether (BFDGE), bisphenol A diglycidyl ether (BADGE), epoxidized novolaks or mixtures thereof.

In some embodiments, the first resin component comprises a monomeric and/or oligomeric, especially epoxidized, novolak blend with bisphenol A and/or bisphenol F diglycidyl ether, especially with chain-extended bisphenol A and/or F, including in the form of a diepoxidic or higher epoxidic hydrocarbon-based resin component.

In some embodiments, all epoxy resin components comprise two or more glycidyl ester and/or glycidyl ether and/or hydroxyl functionalities and/or that the resin formulation comprises at least one dicyandiamide-based and/or (poly)amine-based and/or amino-and/or alkoxy-functional alkyl-/arylpoly-siloxane-based compound that functions as hardener.

In some embodiments, the second resin component which, for example, is in solid form at room temperature or has been processed in a solvent to give the wet enamel preferably comprises at least one monomeric and/or oligomeric silicon-oxygen-based resin component; the term “resin” already implies that this is an organic silicon-oxygen compound. This is based, for example, on alkyl- and/or arylpolysiloxane and/or on silsesquioxane.

In some embodiments, the second resin component provided for the powder coating formulation is a resin and/or a resin mixture in which at least some of the resin mixture and/or resin-hardener mixture for the insulation system that cures to give a thermoset is a siloxane-containing compound that forms a 13 [O—SiR₂—O]ₙ— backbone in the ready-cured thermoset.

“R” here represents all kinds of organic radicals that are suitable for curing and/or crosslinking to give an insulant usable for an insulation system. In particular, R represents aryl, alkyl, heterocycles, nitrogen-, oxygen- and/or sulfur-substituted aryls and/or alkyls.

In some embodiments, R may be the same or different and represent the following groups:
alkyl, for example -methyl, -propyl, -isopropyl, -butyl, -isobutyl, -tert-butyl, -pentyl, -isopentyl, -cyclopentyl and all other analogs up to dodecyl, i.e. the homolog having 12 carbon atoms;
aryl, for example: benzyl, benzoyl, biphenyl, tolyl, xylenes and comparable aromatics, in particular, for example, all aryl radicals having one or more rings, the structure of which satisfies Hückel's definition of aromaticity,
heterocycles: especially sulfur-containing heterocycles such as thiophene, tetrahydrothiophene, 1,4-thioxane and homologs and/or derivatives thereof,
oxygen-containing heterocycles, for example dioxane,
nitrogen-containing heterocycles, for example those with —CN, —CNO, —CNS, N3 (azide) substituents on the ring(s) and
sulfur-substituted aryls and/or alkyls: e.g. thiophene, but also thiols.

Hückel's rule for aromatic compounds is based on the correlation that planar, cyclically through-conjugated molecules comprising a number of U electrons that can be represented in the form of 4n+2 have exceptional stability which is also referred to as aromaticity.

In some embodiments, the monomeric or oligomeric second resin component functionalized for polymerization, which has a —[O—SiR₂—O]ₙ— backbone, is combined with one or more first resin components containing a —[—CR₁R₂—]ₙ— backbone, selected from the group of the following compounds to give the resin mixture and/or resin-hardener mixture: undistilled and/or distilled, optionally reactively diluted bisphenol A diglycidyl ether, undistilled and/or distilled, optionally reactively diluted bisphenol F diglycidyl ether, hydrogenated bisphenol A diglycidyl ether and/or hydrogenated bisphenol F diglycidyl ether, pure and/or solvent-diluted epoxy novolak and/or epoxy-phenol novolak, cycloaliphatic epoxy resins such as 3,4-epoxycyclohexylmethyl 3,4-epoxycyclohexylcarboxylate, e.g. CY179, ERL-4221; Celloxide 2021P, bis(3,4-epoxycyclohexylmethyl) adipate, e.g. ERL-4299; Celloxide 2081, vinylcyclohexene diepoxide, e.g. ERL-4206; Celloxide 2000, 2-(3,4-epoxycyclohexyl-5,5-spiro-3,4-epoxy)-cyclohexane-meta-dioxane, e.g. ERL-4234; diglycidyl hexahydrophthalate, e.g. CY184, EPalloy 5200; tetrahydrophthalic acid diglycidyl ether, e.g. CY192; glycidylated amino resins (N,N-diglycidyl-para-glycidyloxyaniline, e.g. MY0500, MY0510, N,N-diglycidyl-meta-glycidyloxyaniline, e.g. MY0600, MY0610, N,N,N′,N′-tetraglycidyl-4,4′-methylenedianiline, e.g. MY720, MY721, MY725), and any mixtures of the aforementioned compounds.

Suitable monomeric or oligomeric components that have a —[O—SiR₂—O]ₙ— backbone and have been functionalized for polymerization are glycidyl-based and/or epoxy-terminated aryl-and/or alkylsiloxanes, for example glycidoxy-functionalized, especially glycidoxy-terminated, siloxanes. Suitable examples are a siloxane such as 1,3-bis(3-glycidyloxypropyl)tetramethyl-disiloxane, DGTMS, and/or glycidoxy-terminated phenyldimethylsiloxane and/or phenylmethylsiloxane in monomeric and/or oligomeric form, and in any mixtures and/or in the form of derivatives. In place of the 4 methyl substituents on the silicon in the DGTMS, there may be any of a variety of identical or different alkyl and/or aryl substituents. One of these components that has already been tested is commercially available as “Silres® HP® 1250®”. It has been found that at least difunctionalized siloxanes that are usable for production of thermosets are suitable here.

A commercially available example is the following hydroxy-functionalized polyphenolsiloxane-based compound, which is suitable here, from Wacker AG: “Silres-603”.

Additionally suitable as second resin component in the silicon-oxygen-based powder coating formulation is one or more silsesquioxanes or derivatives of silsesquioxane. This is an organic silicon-oxygen-based compound with cagelike or polymeric structures that contain —[O—SiR₂—O]ₙ— backbone, such as the examples shown below:

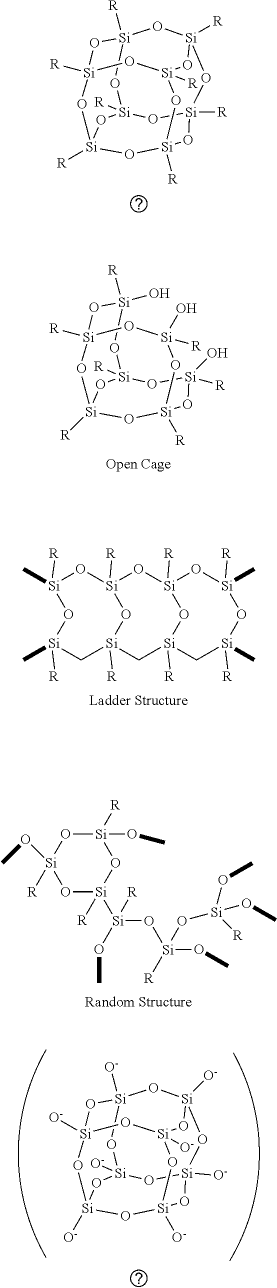

In some embodiments, R here may be the same or different and may be the following groups:
alkyl, for example -methyl, -propyl, -isopropyl, -butyl, -isobutyl, -tert-butyl, -pentyl, -isopentyl, -cyclopentyl and all other analogs up to dodecyl, i.e. the homolog having 12 carbon atoms;
aryl, for example: benzyl, benzoyl, biphenyl, tolyl, xylenes and comparable aromatics, in particular, for example, all aryl radicals having one or more rings, the structure of which satisfies Htickel's definition of aromaticity,
heterocycles: especially sulfur-containing heterocycles such as thiophene, tetrahydrothiophene, 1,4-thioxane and homologs and/or derivatives thereof,
oxygen-containing heterocycles, for example dioxane,
nitrogen-containing heterocycles, for example those with —CN, —CNO, —CNS substituents on the ring(s) and
sulfur-substituted aryls and/or alkyls: e.g. thiophene, but also thiols.

In some embodiments, the formulation further comprises fillers, especially sphere-shaped and/or irregular-shaped fillers. The fillers may be crystalline and/or amorphous.

In some embodiments, the fillers are based on silicon dioxide; for example, they contain fused silica, ground quartz and/or quartz glass.

The resistance of the sprayable powder coating formulation and/or wet enamel paint may be increased by adding fillers, especially mineral or else synthetic fillers, such as ground quartz, fused silica, ground glass, in a proportion by mass of, for example, 5% by weight to 65% by weight when at least a portion of the resin is exchanged for a partial discharge-resistant component. A partial discharge-resistant component refers here to the second resin component based on silicon rather than carbon. This may either be a polysiloxane or a silsesquioxane, or one or a mixture of two or more derivatives of these silicon-containing compounds with oxygen.

It is thus possible to dispense with the use of the large mica platelets bonded to give a tape and to apply and produce the insulation material in the form of a powder coating formulation or wet enamel paint in an automated manner by spraying and/or dipping.

Partial discharge-resistant resins and resin mixtures are, for example, those in which the polymeric constituent present is a component with a —[O—SiR₂—O]ₙ— backbone as secondary constituent of the resin mixture and/or resin-hardener mixture, e.g. to an extent of less than 50 mol %, to an extent of less than 40 mol %, or to an extent of less than 30 mol % of the polymerizable resin mixture and/or resin-hardener mixture.

Suitable hardeners are cationic and anionic curing catalysts, for example organic salts such as organic ammonium, sulfonium, iodonium, phosphonium and/or imidazolium salts, and amines such as tertiary amines, pyrazoles and/or imidazole compounds. Examples of these include 4,5-dihydroxymethyl-2-phenylimidazole and/or 2-phenyl-4-methyl-5-hydroxymethylimidazole. Alternatively, it is possible to use compounds containing oxirane groups, for example glycidyl ethers, as hardener. Just like the base resin, it is also possible to partly or wholly replace the harder alternatively or additionally with a compound having a —[O—SiR₂—O]ₙ— backbone, also called a siloxane-based compound here.

In some embodiments, for example, one or more fractions of nanoparticulate filler are added, especially those based, for example, on quartz, SiO₂.

It is additionally possible here to add an additive, especially a sintering additive, for example based on an organic phosphorus compound. The organic phosphorus compound catalyzes the fusion and/or sintering of SiO₂ nanoparticles that are simultaneously present to give vitreous regions in the resin. For example, this produces a vitreous region as barrier layer in the insulation system.

In some embodiments, there is a combination of the sintering additive and the nanoparticulate filler in the formulation because this may result in formation of vitrified regions that show a particularly good insulating effect in the finished thermoset in the presence of an electrical discharge. The most recent installations of such ready-cured insulants show an increase in lifetime by a factor of 8.

The production of a main insulation and/or an external corona shield and/or a terminal corona shield by spraying of a powder coating and/or a wet enamel makes the manual application of mica tape superfluous and allows problem-free automation of the production. Disclosed here for the first time are a powder coating and/or a wet enamel for automated production of all or at least some components of an insulation system of an electrical rotating machine.

What is claimed is:

1. A powder coating or wet enamel for production of an insulation system of an electrical machine including a curable resin-resin or resin-hardener mixture in solid form as a powder coating formulation at room temperature or processed in a solvent to give a wet enamel, the mixture comprising:
a first hydrocarbon-based resin component with at least two epoxy groups;
second silicon-oxygen-based resin component with at least one hydroxyl functionality; and
a hardener and/or an initiating catalyst,
wherein the first resin component is predominant by compostion.

2. The mixture as claimed in claim 1, wherein the first resin component comprises a monomeric and/or oligomeric diepoxidized epoxy resin, cycloaliphatic epoxy resin, diglycidyl ether resin and/or epoxidized novolak resin.

3. The mixture as claimed in calim 1, wherein the second, resin component comprises a monomeric and/or oligomeric glycidyl-based and/or epoxy-terminated and/or hydroxy-terminated and/or hydroxy-functionalized aryl- and/or alkylsiloxane compound.

4. The mixture as claimed in calim 1, wherein the second, resin component comprises a monomeric and/or oligomeric silsesquioxane compound.

5. The mixture as claimed in claim 1, further comprising fillers.

6. The mixture as claimed in claim 5, wherein the fillers are at least partly electrically conductive.

7. The mixture as claimed in claim 5, wherein the fillers are at least partly electrically insulating.

8. The mixture as claimed in claim 5, further comprising additives and/or sintering aids.

9. The mixture as claimed in claim 1, further comprising a cationic hardener with a compound selected from the group of the organic salts, such as organic ammonium, sulfonium, iodonium and/or phosphonium salts.

10. The mixture as claimed in claim 1, further comprising an anionic harder with at least one compound selected from the group of the imidazolium salts and amines, such as tertiary amines, and/or from the group of the cyanamides, for example dicyanamide, and/or pyrazoles and/or imidazole compounds.

11. A method of producing one or more components of an insulation system of an electrical rotating machine, the insulation system including a main insulation, an outer corona shield and/or a terminal corona shield, the method comprising:
a) providing a powder coating formulation and/or a wet enamel mixture comprising a first, hydrocarbon-based resin component and a second, silicon-oxygen-based resin component, and a hardener and/or a catalyst component,
b) applying the mixture to the coil or bar to product the main insulation and/or the outer corona shield and/or the terminal corona shield; and
optionally repeating a) and b) until a given insulation thickness has been attained.

12. The method as claimed in claim 11, further comprising providing an electrically conductive powder coating formulation or an electrically conductive wet enamel by introducing an electrically conductive filler into the powder coating formulation and/or into the wet enamel.

13. The method as claimed in claim 11, wherein powder coating includes spraying the powder coating formulation and/or the wet coating onto the heated substrate, followed by cooling.

14. The method as claimed in claim 11, wherein powder coating includes dipping in a fluidized bed of powder coating.

15. The method as claimed in claim 11, performed in an automated manner.
